(19) United States
(12) Patent Application Publication
(10) Pub. No.: US 2024/0302243 A1
(43) Pub. Date: Sep. 12, 2024

(54) Builder Quality Improvement and Cost Reduction with Sensor Data and Analytics

(71) Applicant: Riot Technology, Inc., Albuquerque, NM (US)

(72) Inventors: Brian T. McCarthy, Albuquerque, NM (US); Mackenzie Bishop, Albuquerque, NM (US); Tommy D. Hindmarsh, Madrid, NM (US); Harold Marc Stillman, Greenwich, CT (US); John Freisinger, Albuquerque, NM (US)

(21) Appl. No.: 18/657,541

(22) Filed: May 7, 2024

Related U.S. Application Data
(63) Continuation-in-part of application No. PCT/US22/50130, filed on Nov. 16, 2022.
(60) Provisional application No. 63/281,061, filed on Nov. 18, 2021.

(51) Int. Cl. G01M 3/26; B60L 53/64; G06F 3/04815; G06F 3/04817; G06T 19/00

(52) U.S. Cl. CPC G01M 3/26; B60L 53/64; G06T 19/006; G06F 3/04815; G06F 3/04817; G06T 2200/24

(57) ABSTRACT

The present invention provides a house system comprising a plurality of sensors, each configured to sense conditions of one or more house electrical or mechanical systems, one or more environmental conditions relating to the house, or a combination thereof; a plurality of devices, each configured to control the operation of one or more house electrical or mechanical systems; a compute module, comprising data storage local to the compute module and a programmed data processor configured to apply machine learning to develop a model of one or more conditions relating to the house, responsive to one or more of a plurality of conditions relating to the house; a communication interface configured to communicate information from the compute module with an external communications network accessible by one or more parties relating to the house.

### TECHNICAL FIELD

The present invention is related to the field of building maintenance issue identification, evaluation of quality of design evaluation for continuous building improvements, performance efficiency and cost reduction in building and operating residential dwellings.

### BACKGROUND

In conventional construction of residential dwellings, systems in the building are built and installed without sensor data collection, without data analytics and without machine learning and pattern recognition. Any data on the status or performance of the building systems is collected in conventional construction with manual ad hoc methods. Since collection is ad hoc, a baseline for the building or the systems does not exist. There is no continuous data collection, or time-stamped information. Detection of error conditions and management of systems to avoid errors or to improve performance is not possible. Additionally, conventional methods do not allow for battery backup load management or the optimization of energy efficiency through solar battery storage load management. Additionally, where there are some sensors installed at homes, the power to sensors, in conventional construction, uses batteries for sensors and controlled valves and switches. Consequently, the systems can be vulnerable to power loss and interruptions.

Current approaches in residential construction limit management of short-term performance issues and long-term design evaluation of the residential buildings. The short-term maintenance issues are not captured with current methods because there is no centralized data repository in existence that captures the data from a variety of sensors that exist in a ‘multi-variable’ platform to capture performance data from residential homes. Subsequently, homeowners are unaware of building performance issues, maintenance issues and resource inefficiencies. Additionally, machine-learned and pattern recognition of normal patterns are nonexistent and thus cannot be made available for comparison to error conditions that are indicated by local sensors then evaluated using cloud data and analytics with a return notification for resolution to a local control module. The long-term building design improvement and performance evaluation are not captured at present since there is no continuous data collection to the cloud from local sensors for this purpose. The aggregated data used for analytics by the builder, insurance provider, homeowner and other constituents are not available to these users with current approaches. For solar systems integrated with battery storage, current practices utilize an initial value of battery storage and employ a basic linear depletion calculation for managing demand load. The inability to use high resolution sensing and management of batteries can lead to reduced battery lifetime and reduced efficiency in managing loads.

### SUMMARY OF INVENTION

Embodiments of the invention provide building methods and systems, described herein in connection with examples of how this is being applied to a specific use-case involving building sensors, data and analytics. The local data collection controller can utilize source code software from the Home Assistant open-source library, along with other open-source libraries. This entire Internet of Things (IoT) system can be Power over Ethernet (PoE) powered and controlled, there is no additional wiring beyond typically installed ethernet Cat 6 cable and corresponding jacks and terminations required. The process for procurement by builders can be an automated configuration and pre-programming system with the same cloud-based data information about homeowner, contact email, sensor types and locations and builder information used for procurement and commissioning and ongoing operation for the life of the system. The sensors are located using the layout design provided by the builder and that information is integrated with the automated provisioning system. The builder receives sub-kits that are pre-paired and pre-packaged, specifically organized for each building trade. These sub-kits are arranged in an order that corresponds with the construction sequence, facilitating easier integration for construction professionals.

These methods, processes, and a curated set of aggregated data and charts can be made available to builders of new or existing single family or multifamily residential dwellings, the homeowners can have access control at a level that is higher than the builder or related 3^{rd} party (examples include insurance provider, utility provider, or other home maintenance or service provider).

The application defines a novel approach for collecting, analyzing, and making available all essential data and analytics related to performance and maintenance issues requiring immediate attention and resolution. Also, long-term costs of maintenance by type and location to builders to guide both issue identification, quality design improvements, and reduce the cost of building and operating residential dwellings. The sensed state can be communicated using an interface (MQTT or other) to and from the cloud.

(The term “Cloud” refers to a worldwide network of servers, each serving a distinct purpose. These servers host a wide range of services that enable the creation, operation, and management of various applications. The cloud provides on-demand access to computing power, database storage, applications, and other IT resources via a service platform that users can access over the internet.)

In some embodiments of the present invention, Power over Ethernet (PoE) is used to provide power and future communication to an entire suite of sensors, valves, switches, and even the local controller. The PoE approach ensures power is always available when needed for all sensors and devices. In some embodiments, communications and control are through cloud communication to remote devices such as smartphones or tablets. Some embodiments collect machine learning, with pattern recognition, minute by minute to profile usage of electrical loads and battery status. This allows the system to manage battery storage in high resolution in increments throughout the 24-hour periods to better manage load shedding based on time of use aggregated data. This may be augmented by machine learned pattern recognition.

Some embodiments of the present invention provide a house system comprising (a) a plurality of sensors, each configured to sense conditions of one or more house electrical or mechanical systems, one or more environmental conditions relating to the house, or a combination thereof; (b) a plurality of devices, each configured to control the operation of one or more house electrical or mechanical systems; (c) a compute module, comprising data storage local to the compute module and a programmed data processor configured to apply machine learning to develop a model of one or more conditions relating to the house, responsive to one or more of (1) present values from one or more of the sensors, (2) historical values from one or more of the sensors, (3) day of the week, (4) time of day; (c) a communication interface configured to communicate information from the compute module with an external communications network accessible by one or more of (1) a builder associated with the house, (2) an owner of the house, (3) a resident of the house, (4) a utility service, (5) an insurer of the house, (6) a warranty service provider; (7) suppliers of information concerning weather or other environmental conditions relating to the house.

In some embodiments, (a) the plurality of sensors comprises a plurality of moisture sensors, responsive to humidity in the air in respective regions of the house; (b) the compute module is configured to use a model of moisture levels adjusted to present and past environmental conditions, present and past state of HVAC systems, and present and past humidity signals from the plurality of moisture sensors to determine if the present humidity (or indoor air quality) signals indicate a presence of mold or rot in one or more regions of the house, and, if so, communicating an indication of the presence of mold or rot using the communication interface.

In some embodiments, the compute module is further configured to control one or more HVAC systems associated with the house to reduce humidity in a region where mold or rot has been determined.

In some embodiments, the sensors further comprise one or more air sensors configured to sense materials in the air in one or more corresponding regions of the house, and where the model is further responsive to present, past, or both signals from the air sensors.

In some embodiments, (a) the plurality of sensors comprises a plurality of moisture sensors, each mounted in soil near a respective region of the foundation; (b) the compute module is configured compare present values of moisture sensor signals with a model that indicates expected values of moisture sensor signals responsive to one or more of (1) historical values of moisture sensor signals, (2) weather conditions in the area of the house; and configured to determine a foundation settling condition if the present values of moisture sensors differ from the expected values by more than a threshold amount for more than a threshold time, and, if so, communicating an indication of the presence of a potential foundation settling or subsidence condition using the communication interface.

In some embodiments, (a) the plurality of sensors comprises a plurality of moisture sensors, each mounted in soil near a respective region of the house; (b) the compute module is configured compare present values of moisture sensor signals with a model that indicates expected values of moisture sensor signals responsive to one or more of (1) historical values of moisture sensor signals, (2) weather conditions in the area of the house; and configured to determine a water leak condition if the present values of moisture sensors differ from the expected values by more than a threshold amount for more than a threshold time, and, if so, communicating an indication of the presence of a water leak condition using the communication interface.

In some embodiments, the plurality of sensors comprises a flow sensor configured to sense water flow into the house, and one or more sensors configured to sense operation of a corresponding water-consuming system of the house that is presently consuming water, and the computer system is configured to compare the flow of water in the house with flow of water consumed by the water-consuming systems of the house and to determine a water leak condition if the water flow into the house exceeds the water consumed, and to use the communication interface to communicate a water leak condition.

In some embodiments, the compute system is further configured to close a valve preventing water flow into the house if the water consumed is indicated as zero and the water flow into the house is greater than zero.

In some embodiments, the house has a HVAC system configured to control a plurality of regions of the house separately, and wherein the sensors comprise a plurality of temperature sensors, each configured to sense the temperature in a region of the house, and wherein the sensors comprise a plurality of occupancy sensors, each configured to sense occupancy of a region of the house; and wherein the compute module is configured to determine regions of the house that are occupied and to control the HVAC system such that energy consumption for HVAC in unoccupied regions is reduced.

In some embodiments, the compute module is configured to determine a predicted occupancy responsive to present occupancy, historical occupancy at similar times of day and days of week, and to control the HVAC system such that energy consumption for HVAC in regions that are unoccupied actually and according to the predicted occupancy is reduced.

In some embodiments, the system further comprises a plurality of electrical switches, each configured to control the flow of electrical power to a subset of the house's electrical system, and wherein the compute module is configured to include a model representing expected electrical energy usage of each subset correlated with one or more of time of day, day of week, season of year, current occupancy, environmental conditions; and to selectively terminate electrical power to selected subsets to match expected energy usage with expected energy supply.

In some embodiments, the system further comprises a supply sensor responsive to one or more of (1) current sunlight impinging on solar cells, (2) current battery storage state, (3) signals from an external supplier of electrical energy, and wherein the computer module is configured to determine an expected electrical energy supply responsive to the supply sensor and to a model relating future expected electrical energy supply to values from the supply sensor and one more of time of day, day of week, season of year, and environmental conditions.

In some embodiments, the compute module is further configured to accept a forecast of future environmental conditions and to determine an expected electrical energy supply responsive also to the forecast.

In some embodiments, the sensors comprise (1) one or more air humidity sensors, each responsive to air humidity in a corresponding region of the house; (2) one or more air temperature sensors, each responsive to air temperature in a corresponding region of the house; (3) one or more leak detection sensors, each responsive to a leak of water from a water system associated with the house; (4) one or more substrate moisture sensors, each responsive to moisture adjacent a region of a foundation of the house; (5) one or more HVAC filter status sensors, each responsive to a status (ie, filter cleanliness) of a filter in a HVAC system of the house; (6) a water meter, responsive to water incoming to the house; (7) one or more air quality sensors, each responsive to air quality in a corresponding region of the house.

In some embodiments, the compute module is configured to use a model of moisture levels adjusted to present and past environmental conditions, present and past state of HVAC systems of the house, and present and past humidity signals from the plurality of air quality and humidity sensors to determine if the present humidity signals indicate a presence of mold or rot in one or more regions of the house, and, if so, communicating an indication of the presence of mold or rot using the network interface; and to determine a replacement status of a filter in a HVAC system of the house responsive to a HVAC filter status sensor and, if the replacement status indicates replacement of the filter, then communicating an indication of the filter replacement status using the communication interface.

Some embodiments further comprise a network of wiring conforming to Cat6 requirements and configured to provide data communication between the sensors and the computer module, and can provide power to the sensors.

Some embodiments of the present invention provide a house system comprising a plurality of control devices, each configured to affect performance of an electrical or mechanical system of the house, and a compute module configured to communicate with the control devices and, when the house is determined to be vacant, to communicate with the control devices to place the associated electrical and mechanical systems in operation to reduce risk of damage to the house and to reduce resource uses relative to operation when the house is not determined to be vacant.

In some embodiments, the compute module is configured to determine that the house is vacant responsive to one or more of (1) one or more motion sensors, (2) time of day, (3) day of the week, (4) historical values of one or more sensors associated with the house.

In some embodiments, the control devices comprise one or more of (1) electrical switch that turn off selected electrical circuits responsive to a compute module indication that the house is vacant; (2) water valve that turn off water supply to one or more water usage devices responsive to a compute module indication that the house is vacant; (3) HVAC controller that reduces the difference between ambient temperature outside the house and a controlled temperature inside the house responsive to a compute module indication that the house is vacant.

Some embodiments of the present invention provide a house system comprising a plumbing network establishing fluid communication between a water inlet to the house and a plurality of control valves, where each control valve, when open, communicates water to one or more water usage devices associated with the house, distinct from water usage devices in communication with other control valves; one or more sensors configured to detect one or more of (1) an environmental condition that will impair performance or integrity of a water usage device; (2) water flow through a control valve that is different that the water usage expected from a current operating state of the water usage devices associated with that control valve; and a compute module configured to turn off a control valve associated with the water usage device subject to the environmental condition or associated with the different water flow.

Some embodiments of the present invention provide a method of connecting a plurality of systems, each comprising one or more of (1) an appliance, an HVAC system or component thereof, (2) a plumbing system or component thereof, (3) an electrical system or component thereof; comprising (a) providing an internal data communications network within a house, configured to transmit data to and receive data from each of the plurality of systems; (b) providing a compute module, configured to transmit data to and receive data from the internal data communications network; and configured to transmit data to and receive data from an external data communications network; and configured to associate each system with one or more external monitors or accounts, where an external monitor or account is allowed by the compute module to review data from the associated system and to provide commands to the associated system.

### BRIEF DESCRIPTION OF THE FIGURES

FIG. 1 is a schematic illustration of an example embodiment of the invention.

FIG. 2 is a schematic illustration of an example embodiment of the invention.

FIG. 3 is a schematic illustration of an example embodiment of the invention.

FIG. 4 is a schematic illustration of an example embodiment of the invention.

FIG. 5 is a schematic illustration of an example embodiment of the invention.

FIG. 6 is a schematic illustration of an example embodiment of the invention.

FIG. 7 is an illustration of sub-kits according to an example embodiment of the invention.

FIG. 8 is an illustration of sub-kits according to an example embodiment of the invention.

### DESCRIPTION OF INVENTION

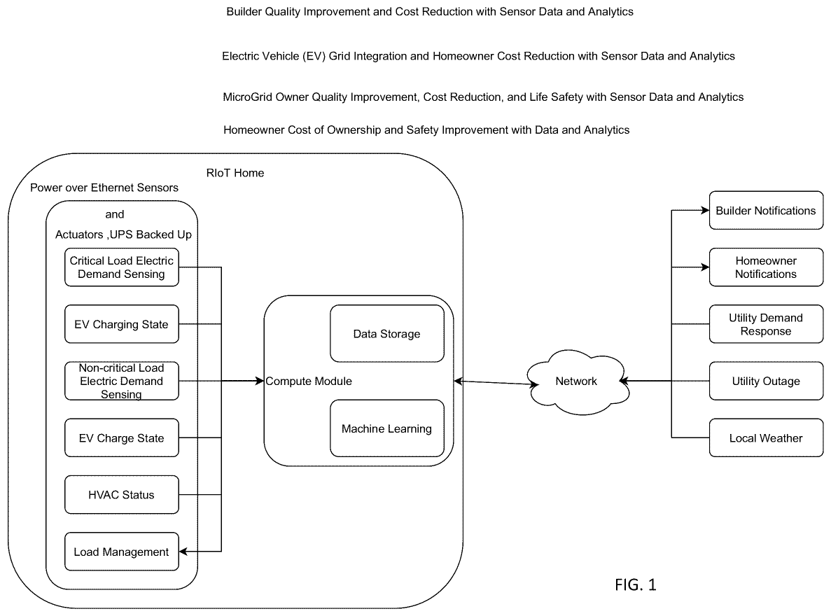

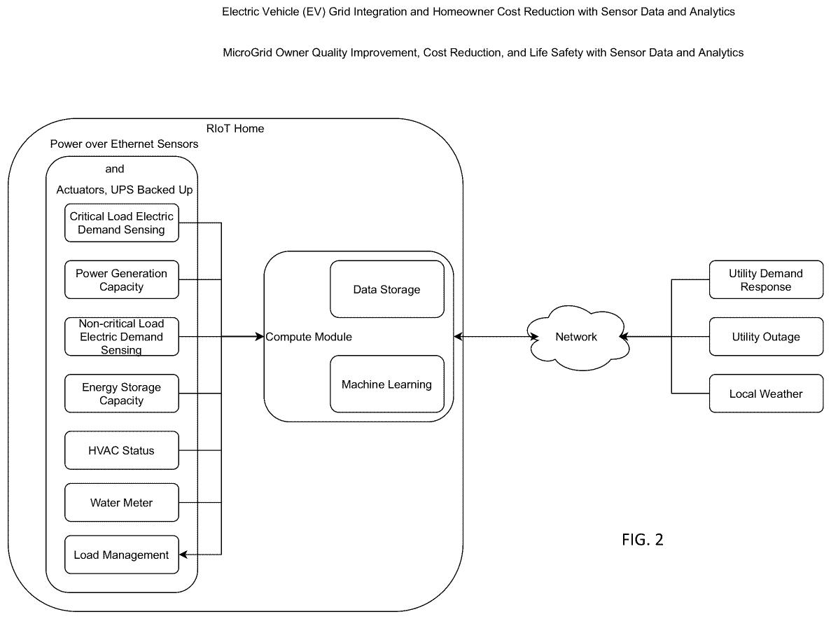

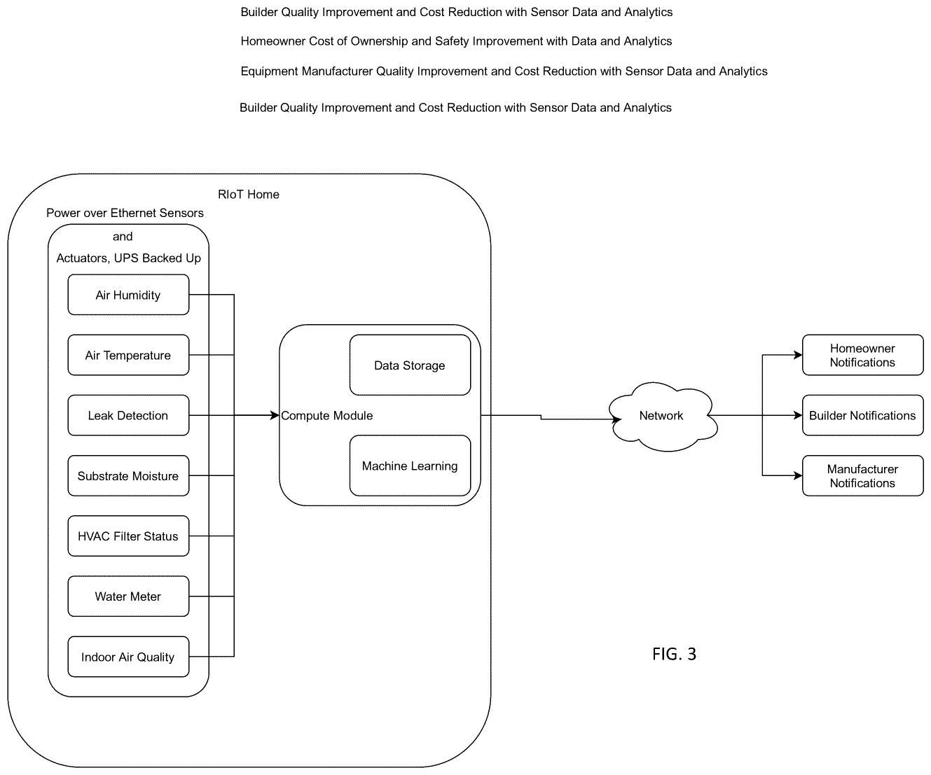

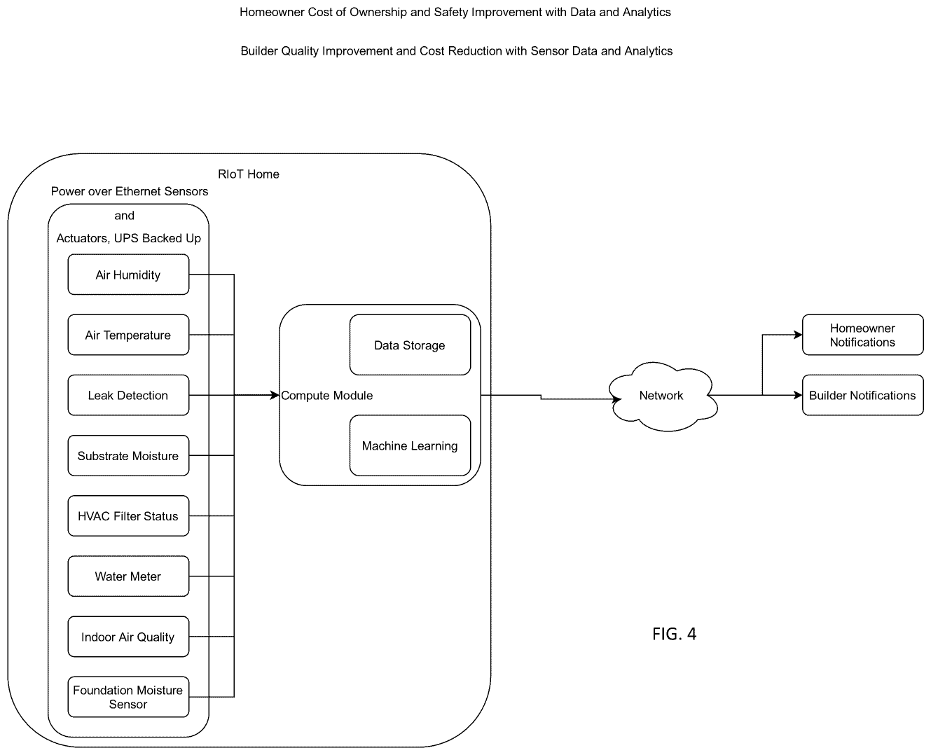

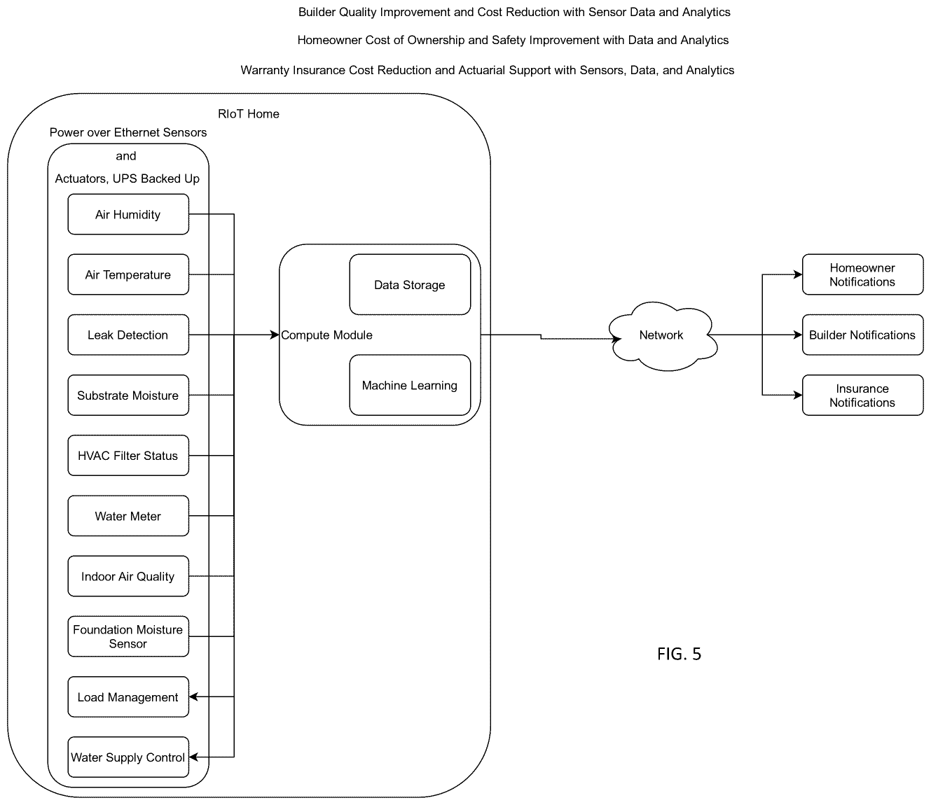

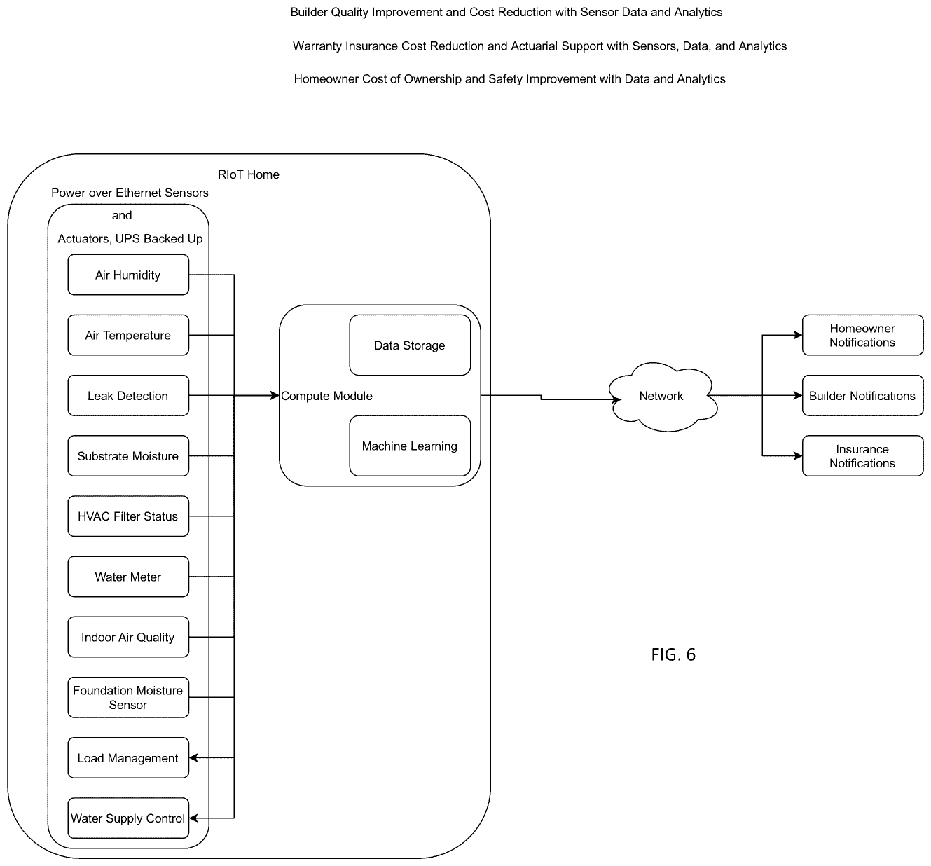

FIGS. 1-6 provide schematic illustrations of example embodiments of the invention. A home can be constructed according to any of various techniques known in the art. The home incorporates a plurality of sensors and actuators, valves, lights, controller and human interface devices and software to implement all associated functionality described, as in the examples that follow. Communications are sometimes described in the context of MQTT. MQTT is an OASIS standard messaging protocol for the Internet of Things (IoT). Those skilled in the art will appreciate other communications techniques that can be suitable. There is not any specialized knowledge of the communications techniques necessary for any users. The system uses an abstracted visual interactive menu via an intuitive language and icon driven interface for any users. There are menu driven human interface techniques that are software coded to show all sensor current status, this is implemented with a unique Virtual Reality system.

A Critical Load Electric Demand Sensing sensor comprises one or more sensors that sense critical electrical loads of systems within the building and communicate these loads using an MQTT interface. These allow for automated load management within the home to provide lower cost of electricity to homeowners. These also allow for eliminating non essential loads when the home is limited to only battery storage for management of power input to loads to extend battery availability during grid off operation.

An EV Charging State sensor comprises one or more sensors that sense the state of an Electric Vehicle charging system, e.g., the state of the system, the state of an electrical vehicle being charged by the system, or a combination thereof. The sensed state can be communicated up to the cloud using an MQTT interface.

A Non-critical Load Electric Demand Sensing sensor comprises one or more sensors that sense electrical loads of systems within the building and communicate these loads using an MQTT interface up to the cloud.

The process of identifying all loads in a house is facilitated through an API (Application Programming Interface) method during commissioning. The house loads types and usage amounts are identified using an automated process that is menu driven at the local controller and includes a sequence of steps of turning off various of the loads (e.g., one load at a time, or a defined group of loads such as lights in a room or area), then measuring reduction in overall usage, then turning back on each load in sequence. The load type is input by the user at the time of this subtractive measurement process by inputting a chosen name for the load. This objective can be achieved by positioning a smartphone, tablet, or similar device in close proximity to the location of the electrical outlet, marking its position, and assigning a name to it. This Augmented or Extended Reality feature of placing a smartphone, tablet, or similar device at any connected IoT device is a separate feature of the home system. The comprehensive house load that is input to the cloud for the subtraction is by a load electric demand sensing sensor composed of one or more sensors that sense electrical loads of the house within the building and communicates these loads using an MQTT interface up to the cloud. This method of load identification provides very precise individual circuit-based system identification. This allows for precise load management because each individual electric receptacle is controllable and is maintained as a database function during commissioning. Each individual outlet that is commissioned can be recommissioned at any time by the user running the API. The machine learned energy use patterns by time of day are maintained in the cloud with data sent via the local MQTT interface.

An HVAC Status sensor comprises one or more sensors that sense the state of an HVAC system, e.g., the state of mode, fan activity and temperature of a portion of the dwelling connected to the HVAC system, or state of an HVAC system, or a combination thereof. The sensed state will be communicated using an MQTT interface. The aggregated data is available to authorized users at a local kiosk with intuitive menus and screen icons; this aggregated data is also available to authorized users at a web portal for long term performance analytics. This interface is coded with specialized software with intuitive menus and screen icons. The web-based portal also provides for direct local control by homeowners.

A Load Management sensor comprises one or more sensors that sense high voltage electrical loads of systems within the building and communicates the values locally on wireless communication to the compute module and then these loads are uploaded to the cloud using an MQTT interface.

Signals from the various sensors can be communicated to a Compute Module, that comprises, as an example, a single board computer or other compute or control system that can be integrated with the desired sensors and communications techniques. The Compute Module can have local storage, and an interface to the cloud for data storage and retrieval, and for communications with cloud-based analytics. The Compute Module can send all data to the cloud and for use by a cloud-based Machine Learning capability. Machine Learning capability means pattern recognition capability that is programmed to address each separate use case.

The Compute Module communicates over a network with a plurality of recipients of the information concerning the home. Notifications can be communicated to the cloud. Data from the local computational module can be connected to cloud data and analytics through a standard MQTT interface. Homeowner Notifications can be communicated from the local computational module which is connected to the cloud using data and analytics through a standard MQTT interface. Data can be sent back to the homeowner via the MQTT interface for display and control with the analytics or controls for water and energy flow control and notifications of analyzed house failure conditions. Utility Demand Response can be received via a standard interface with the local utility. Utility Outage notifications can be communicated from the utility to the home via a standard communications interface. Information concerning local weather can be communicated to the home from the cloud. A unique demand response feature in this system is the software coded time-based analytics allowing for time-of-day historical use by loads to be able to make load shedding precise by both load amounts and time of day.

In an example scenario of an embodiment in operation, the cloud uses machine learning pattern recognition algorithm to discover that there is continuous flow of water using a main flow meter sensor. If this flow indicates a time that does not match the desired pattern, for example, continuously for 24 hours, it is recognized as an error condition of a water leak. This information is stored in the cloud. The results of the local moisture sensors that are connected to the local compute module using a standard communications interface between the sensor and the local compute module are also stored in the cloud. Moisture detection sensors are evaluated locally to determine where the leak is detected. That information is sent to the cloud. In the condition that there is no sensor leak detected then the homeowner is notified that there is a leak somewhere in the house and that a service call to locate the leak is required. In the condition that a leak is detected the homeowner is notified that there is a leak at the detected location in the house and that a service call to locate the leak is required. This information about when and where the water leak is data that will be used for immediate resolution and for warranty and insurance historical information. The total volume of water lost to a leak can be calculated by the system as well.

Another example scenario of an embodiment in operation is when the cloud uses pattern recognition to discover that there is a change greater than a typical seasonal change for any of one or more foundation moisture sensors. The formula for the normal and error conditions is described here. Moisture sensors can be placed approximately 2′-4′ below the finished grade of the house to measure the moisture content of the soils below the foundation. The variance between these multiple sensors can be measured and evaluated. If this change in moisture indicates an amount that does not match a desired pattern, for example, some percentage moisture increase, greater than the baseline amount for 24 hours, it is recognized as an error condition that could cause a foundation to be compromised. This information is stored in the cloud. The results of the local moisture sensors that are connected to a local compute module using a standard communications interface between the sensor and the local compute module are also stored in the cloud. Moisture detection sensors are evaluated locally to determine where the moisture condition is detected. The baseline normalized amount of moisture is gathered as a pattern recognized amount for 1st 10 days of installation; that information is sent to the cloud. If the condition that there is excessive or abnormal moisture detected, e.g., greater than a high limit percentage, over the baseline amount determined during commissioning, then the main water valve is shut off, homeowner is notified that there is excessive moisture or water flow somewhere in the house and that a service call to locate the source of the moisture is required. In the condition that proximity or other sensors indicate there is no occupancy then the homeowner is notified via the cloud to their mobile device. This information of when and where the moisture is data that will be used for immediate resolution and also for warranty and insurance historical information.

Another example scenario of an embodiment in operation involves machine learning using a pattern of occupancy in each area in the house. The occupancy of each area is sensed by the computational module via occupancy sensors located in the area. The occupancy results are sent to the cloud and the normal occupancy normalized by time of day; no presence for 15 minutes results in the HVAC system being shut down or limited (e.g., to maintain a minimum temperature for operation or safety of water, electronic, or other systems) for that area. The HVAC system is a zoned system that is purchased and includes the ability to accept shutdowns of each area (often called a zone) separately from the whole. The shut down is done with a standard communications interface to the zoned HVAC system with local control module communications interface. That HVAC shutdown command is lifted immediately after a presence is indicated in that HVAC zoned area is newly occupied, or can be done predictively based on learned patterns of occupancy, or sensed motion of occupants such as approach of an occupant's vehicle or mobile device to the house.

Another example scenario of an embodiment in operation involves sensor data and analytics to intercept maintenance and operational issues with forced air furnace filters, accomplished with continuous time-based maintenance door open sensor evaluation combined with pressure sensor readings on the input and output side of filter area of furnace, resulting in a pressure differential indicating an obstructed filter. The sensors provide input to the compute module which sends them to the cloud via the MQTT standard interface. The cloud data is managed as limits in this case with the pressure being abnormally higher than the normal state and the door open is stored as a time-based event that is compared to the pressure error condition to notify the homeowner that the filter needs replacing and when the maintenance door was last opened to access the filter cartridge. This is also an optimized energy use function as well as maintenance function. A significant value is for warranty response by builders during an initial (e.g., first year) warranty period.

Another example scenario of an embodiment in operation involves the value of the collected data with machine learning to provide artificial intelligent house design, after the machine learned patterns are made in the cloud then deep learning and artificial intelligence can be used to create an optimal home design by climate and occupancy type using learned patterns of construction and design, HVAC implementations and clean air features.

Another example scenario of an embodiment in operation involves an expected 35%-40% water reuse savings by routing gray water to a prescribed geographical location for a home or homes and the feature of rerouting gray water for gardening or storage needs to be quantified to properly account for sewage waste with gray water subtraction. The cloud-based data and analytics provides for sensor data via flow of gray water to be able to implement this feature in one or more homes that are tied to municipal utilities. This is to allow for the municipal incentive to homeowners implement gray water and not be charged for sewage costs for sewage that was not used as well as to enable proper sizing local or municipal water and sewage infrastructure. The long-term data and analytics provided with this cloud based system can be used by machine learned patterns of water and sewage designs. The output of the machine learned design can be used for deep learning and artificial intelligent infrastructure designs for multiple home developments. This is a water savings feature that can facilitate reduced environmental impact of residential housing on the environment.

Another example scenario of an embodiment in operation involves the recirculation of hot water from point of hot water source to points of use that can save an amount of water that is equal to the flow times distance times the water to the use points, shower, or faucets. The recirculation pump is activated conditionally based on the use of sensors to detect occupancy or presence at the point of use, bathroom, kitchen or other hot water use location. This can result in significant savings and optimization in water use even with low flow shower heads. The amount of savings can be calculated with the sensor inputs and machine learned patterns that are available for deep learning and artificial intelligent feature input to optimally designed houses using artificial intelligence.

Example embodiments can implement numerous desirable functions; examples are described below.

Sensor data for early detection of increased mold. Sensors that sense moisture can indicate a continuously wet area that is associated with mold growth in a home. Additionally, air quality sensors will continuously monitor the VOC (Volatile Organic Compound) levels inside the home. Certain types of molds grow at parabolic rates and the growth rate of the VOCs in the home, compared with humidity/moisture data will be evaluated to alert a homeowner to the possible presence of mold. The sensor data is sent to the cloud via the MQTT standard interface. In cloud analytics, when such sensors indicate prolonged presence moisture, then the analytic comparison can determine that mold is more likely to be present or increasing. The cloud machine-learning can compare current sensor signals with those recorded historically for this home in the Data Storage. With the software coding algorithm, the comparison determines that mold presence or likelihood is above a threshold, then the information is sent from the cloud to the compute module which in turn communicates a message to Builder and Homeowner indicating mold. Mold can be predicted with historical humidity data coupled with the ongoing air quality data collection in the specialized cloud-based data analytics used allowing preemptive corrective action to be taken. Mitigation of mold collection can also be done with the analytics of collected data at the home with sensor data sent by compute module and then cloud analytics can use humidity sensor data to indicate need to compute module to control HVAC to decrease the mold conditions, (e.g., by reducing the humidity and moisture in portions of the home subject to the increased mold indication).

Sensor data for early detection of increased rot. Sensors that sense moisture can indicate a continuously wet area that is associated with rot in a home. When such sensors indicate 5 days of continuous moisture, after the compute module has sent data to the cloud then a determination by comparison can determine that rot is more likely to be present or increasing. The information is sent to the compute module and can indicate to the builder and homeowner after the cloud used machine learning pattern recognition algorithm to determine that mold presence or likelihood is above a threshold; this is analyzed with VoCs over a period of time and then the computational module can communicate a signal to Builder and Homeowner indicating rot, allowing preemptive corrective action to be taken. The cloud can send a signal to the compute module using previously sent humidity sensor data to indicate the need to control HVAC to decrease the rot conditions, e.g., by reducing the humidity in portions of the home subject to the increased rot indication. The data can also be made available to warranty and insurance providers for indication of preemptive action taken.

Sensor data for early detection of subsidence. Sensor data for subsidence of foundation issues by measurement of settling of corners can be compared to a baseline start of ground attachment. The machine learning function of the cloud can be used to monitor the data from moisture sensors located under the foundation to identify out of the normal levels of moisture, e.g., 5% for periods of time equal to 24 hours, and then notify homeowner and builder of the potential settling issues. If the amount of water detected exceeds, (e.g 15% above the seasonal norm determined by machine learning, then the main water will be shut off and an indication sent to the builder and homeowner). The normalized data is collected at installation time and creates a baseline value to compare against; specialized data access can allow regional information sharing for this algorithm to allow comparison and analysis relative to other buildings in the same region, (e.g., to determine the effect of unusual weather conditions that are also experienced by other buildings in the region).

Sensor data for early detection of structural issues like floor settling. Sensor data for subsidence of floor issues by measurement of settling of corners compared to a baseline start of foundation attachment. The machine learning function of the cloud can be used to monitor the data from moisture sensors located under the foundation to identify out of the normal levels of moisture, (e.g., 10% for periods of time equal to 24 hours, and then notify homeowner and builder of the potential settling issues). If the amount of water detected exceeds, (e.g. 15% above the seasonal norm determined by machine-learning, then the main water will be shut off and an indication sent to the builder and homeowner).

Sensor data for energy savings by zone, for immediate analysis of building operation, the sensor data for energy use by zone or can be derived from calculation of HVAC zone shutdowns that use machine-learning using a pattern of occupancy in each area in the house. The occupancy of each area is sensed by the computational module via occupancy sensors located in the area. The occupancy results are sent to the cloud and out of the normal occupancy of no presence for, (e.g. 30 minutes results in the HVAC system being shut down for that area). This is a schedule that can be controlled by the homeowner user. The HVAC system is a zoned system that is purchased and includes the ability to accept shutdowns of each area called a zone separately from the whole. The shut down is done with a standard communications interface to the zoned HVAC system. The removal of that HVAC shutdown condition occurs immediately after a presence is indicated in that HVAC zoned area is newly occupied. The homeowner user has the ability to program scenes that turn off and, on the HVAC, lights and water. The scenes do not require any special programming knowledge and are menus driven on the local control screen. These scenes are provided with a drop-down menu that provides scheduled functions to be included.

Sensor data for short-term use within the building envelope for humidity. The sensor data for detection of humidity in areas of the home can be transferred to the cloud for data storage and analytics, this information can provide near term maintenance mitigation for excessive humidity and long-term design improvement information for HVAC design.

Sensor data for equipment maintenance, immediately required, within the building envelope. The sensor data for equipment maintenance comprises, as examples, leak detection for water heaters and washing machine areas. These leak detection sensors are placed throughout the house, as well as under the foundations.

Machine Learning algorithm for pattern usage with Sensor data and output control by zone for water leak detection. Cloud based machine learning pattern recognition algorithms can discover that there is continuous flow of water using a main flow meter sensor. If the flow pattern deviates from the expected sequence, such as not running continuously for 24 hours, a machine learning-based pattern recognition algorithm can identify this discrepancy as indicative of an error condition, potentially signaling a water leak. This information is stored in the cloud. The results of the local moisture sensors that are connected to the local compute module using a standard communications interface between the sensor and the local compute module are also stored in the cloud. Moisture detection sensors are evaluated locally to determine where the leak is detected. That information is sent to the cloud. In the condition that there is no leak detected then the homeowner is notified that there is a leak somewhere in the house and that a service call to locate the leak is required. In the condition that a leak is detected the homeowner is notified that there is a leak at the detected location in the house and that a service call to locate the leak is required. This information about when and where the water leak is data that will be used for immediate resolution and for warranty and insurance historical information.

Sensor data for structural issues by building type and location. This is a method of collecting raw data and performing time-based analytics on detected failures for building design improvements. This can also be made available for short-term warranty coverage and long-term insurance coverage.

Sensor data for energy savings by zone, long-term data. This is an analytics function performed in the cloud by accessing raw data from the main CT and calculated by savings of zone shutdowns. This information is used for building design improvements and equipment performance evaluation and can be provided to equipment manufacturers in addition to builders.

Sensor data for short-term building repair by aggregation within the building envelope, by type of failure. This is an analytics function performed on raw data for short term warranty information to builders and long-term repairs information to actuarial calculation by insurance companies.

Sensor data for equipment maintenance completed within the building envelope. This is an analytics function performed on raw data for short term warranty information to equipment manufacturers, builders and long term equipment repair information to actuarial calculation by insurance companies.

Machine Learning for patterns of use and Sensor data for water use by zone inside the building envelope and outside the building envelope. This is a sub-component of water leak detection and building settling.

Evaluate costs associated with water waste due to small leaks. This is the financial and environmental impact completion of the water leak detection in gallons or dollars saved.

Evaluate or mitigate environmental impact with sensors and time-based identities. This is the financial and environmental impact completion of the water leak detection in gallons or dollars saved. The carbon based energy used will be quantified and the calculated energy saved by HVAC zone control subtracted will equal the reduced carbon savings. The mitigation aspect will be via the deep learning and input to artificially intelligent designs either as features or complete designs.

Builder performance scheduling for optimal energy to value operation. This is a machine learned function where the machine learned patterns of HVAC temperature and humidity settings are evaluated for optimization of energy savings with occupancy. This can also be performed by geographical region and by season.

The use of the water heater during periods in the daily cycle. This is a control function of turning off the water heater during time of nonuse in periods determined by machine learning for the particular home and occupancy. This will also be used as a subcomponent function for heat storage for demand response functions.

Sensor data for slow leaks of pressure release valves with placement of thermal sensor several feet from drain line, e.g., these sensors are placed at the drain side of a storage water heater to indicate a partially open pressure relief valve; the data is sent to cloud and failure returned to local compute module via the MQTT for mitigation by homeowner. Cold temperature will be with an operational pressure relief that is operating properly and warmer temperature can indicate a slow leak in areas serviced by appliances.

Pressure sensor data for filtration areas to manage the preventative maintenance schedule of equipment; forced air HVAC systems will have improved life and near term optimal improvement with this subcomponent to filter change notifications.

Energy efficiency modeling. These are use cases that are derived from sensor data collection, e.g., in a use case of attic installation of R60 the data for energy use can be compared with the temperature and humidity in an adjacent building with a superior or inferior level of insulation to compare energy usage and performance.

Sensor data for use within the building envelope for temperature humidity and dewpoint to determine attic space performance, with respect to insulation and ventilation. These are use cases that are derived from sensor data collection e.g. In a use case of attic installation of R60 the data for energy use would be compared with the temperature and humidity in an adjacent building location for energy use.

Sensor data for all zones to determine air quality performance. All sensor inputs are automatically transferred to the cloud for long term performance analysis and possible immediate notification to homeowners. The system provides immediate notifications to users and aggregated data for long term system performance evaluation, for users. These air quality sensors, such as the Digital Air Pollution Monitor, the Formaldehyde (HCHO) and Total Volatile Organic Compounds (TVOC) Sensor, the CO2 Detector, the PM 10 and PM 2.5 Particle Sensor, the hydrogen peroxide meter to optimize disinfection dosages, and Smart Air Quality Monitor Detection Devices, offer homeowners valuable information on air quality for health and safety. Sensor data for all zones to determine HVAC performance within ASHRAE standards. These are temperature and humidity sensors that are collected by the computational module and sent to the cloud via the MQTT standard interface. The cloud can collect data and perform analytics to show time-based performance.

Sensor data for appliance usage, for long-term energy costs savings with respect to envelope design. These are derived energy uses starting from the CT sensor at the main panel that are collected by the compute module and sent to the cloud via the MQTT standard interface. The cloud will collect the data and perform analytics to show time-based performance.

Sensor data for water usage outside the envelope is continuously collected locally and sent to the cloud continuously via the MQTT interface for long term performance analysis and possible immediate homeowner notification, with respect to landscape design. These are derived for water use starting from flow meters at the water main that are collected by the compute module and sent to the cloud via the MQTT standard interface. The cloud can collect the data and perform analytics to show time-based performance.

Sensor data for subsidence of foundation issues by measurement of settling of corners compared to a baseline start of ground attachment. Machine learned data can be used to recognize a normal pattern throughout the year of moisture; this can help to eliminate false readings that are not compromising the home. The limits set for moisture, e.g., initially set at 1% moisture increase over a 24 hour period, can be adjusted with machine learned patterns that will adjust limits to proper values. This is a continuously improved data collection feature.

Freeze-protection drain sensor and control(s) for winterization to release water from pipes within the building envelope. In climates that experience water pipe freeze damage the sensors used to collect temperature are sent to the cloud via the local compute module via the MQTT standard interface. The cloud enhanced control system will use an analytical decision-making process that will also intake local weather data to determine the longevity of the freezing conditions along with the sensor temperature input to send control signals back to the local compute module, to mitigate the freeze damage. This will be performed by actuating valves to shut off the supply of water to plumbing locations that have exposure to the exterior and/or freezing temperatures and also the opening of drain valves from the pipes to a temporary drain area that is below the lowest point to enable free gravity flow to drain the pipes being protected. This application incorporates a novel method of ‘plumbing’ the house (via a ‘T’ or manifold) in a new way—to isolate the zone(s) of the home's plumbing into ‘interior’ and ‘exterior’ zones. This will allow the exterior plumbing (unconditioned) to be shut off, while allowing the interior plumbing (conditioned) to continue to function normally.

Design feature data and analytics showing value of building component features for type of construction. Machine learning of the patterns of energy use by actual occupancy by climate conditions will show the energy, water and maintenance issues based on construction features as known inputs to the machine learned house performance models.

Maintain house configuration, using data, and analytics as a key variable for identifying which house sensors and control configuration(s) provide the optimal value. After the machine learning patterns are made in machine learning then deep learning and artificial intelligence will be used to create the optimal home design by climate and occupancy type using the learned patterns.

Trend analysis of the value of energy optimization by reduced usage by zone control, showing savings on a periodic basis. This is a calculated value using data and analytics that were initially derived from the sensor inputs to the compute module and sent to the cloud via the MQTT standard interface.

Event participation from “opted-in” homeowners to identify events such as hail, high winds, and power outages. The cloud enhanced system will convey the weather predicted potential home damage or life safety concerns. The limit of the prescribed weather mitigation actions will be limited to home envelope barricades or flooding, and life safety will alert the occupants. If there is a no-occupancy sensor for the entire home then there will be alerts sent to mobile devices as well.

Water savings from monitoring valve control routing of drains for grey water reuse from sinks, tubs, and showers. There is an expected 35%-40% water reuse savings by routing gray water to a prescribed geographical location for a home or homes and the feature of rerouting gray water for gardening or storage needs to be quantified to properly account for sewage waste with gray water subtraction, The cloud based data and analytics provides for sensor data via flow of gray water to be able to implement this feature in one or more homes that are tied to municipal utilities.

Pre-circulation to high level water points of use for hot water with occupancy sensor. The recirculation of hot water from point of hot water source to points of use can save an amount of water that is equal to the flow times distance and a function of water temperature differential to the use points, shower, or faucets. This can result in significant savings and optimization in water use even with low flow shower heads. The occupancy sensor will indicate the presence of a user in the bathroom.

Reduce or eliminate mold damage to building integrity, including warranty notification. The cloud based data and analytics already described for mold and rot can be provided to short and long term warranty holders for the home.

Reduce and/or eliminate mold spore exposure to building occupants. The already-described sensors that sense moisture can indicate continuously wet areas that are associated with mold growth in a home providing protection of the occupants from mold spore exposure.

Reduce or eliminate cost to rebuild structure and/or foundation. The already-described foundation and structure settling early indication enables this feature.

Reduce energy cost based on effective utilization of zones, for immediate analysis of building operation. The already-described zone control function enables this feature.

Monitor the building envelope for humidity, to determine possible maintenance required within the attic space. The already-described temperature and humidity process enables this feature.

Monitor air quality, within the building envelope, for mitigation of air quality concerns, including warranty notification. The already-described air quality monitoring enables this feature.

Identify and notify, by zone, any water leak detected to make early correction and/or mitigation possible and/or to enable automatic shutoff, including warranty notification. The already-described water moisture indication for the mitigation of water loss enables this feature.

Identify and notify structural issues by building type and location for mitigation The already-described foundation and structure settling early indication enables this feature.

Evaluate model design for energy use by zone, using sensor data and analytics for long-term data. The amount of savings can be calculated with the sensor inputs and machine learned patterns that are available for deep learning and artificial intelligent feature input to optimally designed houses using artificial intelligence.

Cost of ownership accounting. The amount of savings can be calculated with the sensor inputs and machine learned patterns that are available for direct information to the homeowner. The system is also capable of calculating total energy and water usage, capturing insurance costs, and other associated expenses to establish the overall cost of ownership for the property owner.

Building repair by aggregation within the building envelope, by type of failure. This is made available by data and analytics collection in the cloud for use by builders and warranty holders for actuarial data made into useful information.

Equipment maintenance completed within the building envelope. The amount of maintenance can be calculated with the sensor inputs and machine learned patterns that are available for deep learning and artificial intelligent feature input to optimally designed houses using artificial intelligence.

Water use by zone inside the building envelope and outside the building envelope. This feature is enabled by the data collected and analytics performed on the data.

Mitigate and/or reduce water waste due to small leaks that account for considerable costs and environmental impact with sensors and time-based identities. This is enabled by the already-described water leak detection functions.

Schedule and control performance of certain equipment to ensure optimal energy to value operation. Machine learning patterns are chosen based on deep learning evaluation to implement best in class implementations. The patterns were derived from sensor provided inputs to compute modules and transferred to the cloud via the MQTT standard interface.

Reduce service calls for the preventative maintenance schedule of equipment for homeowners and preempt maintenance costs for building owners, including warranty notification. The cloud based data and analytics will provide the expected expiration of beneficial use or failure of equipment based on equipment provider known data. Continuously updated data from ongoing machine learned patterns can modify the warranty based on learned deviations.

Data for homeowner maintenance actions. Homeowner notifications can be made to them from the cloud based data bank that was created during the system installation for each site.

Data for warranty providers of the need for filter change(s) in HVAC equipment could eliminate supply side over production and possible subsequent equipment life-cycle effects. The already described filter change function enables this feature.

Continuously improved building designs enable optimized energy efficiency modeling. The optimization of the design can be calculated with the amount of savings with the sensor inputs and machine learned patterns that are available for deep learning and artificial intelligent feature input to optimally designed houses using artificial intelligence. The air quality, and carbon energy use minimization are also inputs to deep learning.

Sensor data for use within the building envelope for temperature humidity and dewpoint to determine attic space performance, with respect to insulation and ventilation, This a design feature that provides quantifiable design improvements to the machine learned patterns that will be a feature chosen by the deep learning as an input to the building optimal design.

Sensor data for appliance usage, for long-term energy costs savings with respect to envelope design, The already-described sensor data sent to the cloud via the local compute module will include this as a design feature that provides quantifiable design improvements to the machine learned patterns that will be a feature chosen by the deep learning as an input to the building optimal design.

Sensor data for water usage outside the building envelope with respect to landscape design. The water flow sensor data sent to the cloud via the compute module will be able to calculate the flow to the landscape. There is an expected 35%-40% water reuse savings by routing grey water to a prescribed geographical location for a home or homes and the feature of rerouting gray water for gardening or storage needs to be quantified to properly account for sewage waste with grey water subtraction. The cloud based data and analytics provides for sensor data via flow of grey water to be able to implement this feature in one or more homes that are tied to municipal utilities.

Building Design feature data and analytics showing value of building component features for type of construction. Sensor data sent to the cloud via the local compute module can include this as a design feature that provides quantifiable design improvements to the machine learned patterns that will be a feature chosen by deep learning as an input to the building optimal design.

Building Design features data and analytics for various house configurations, using data and analytics as the key for identifying which house sensor and control configuration is optimal. The continuous improvement on the house configuration of sensors and placement will be data collected as machine learning pattern recognition algorithm and the cloud via the local compute module will include this as a design feature that provides quantifiable design improvements to the machine learned patterns that will be a feature chosen by the deep learning as an input to the building optimal design.

Building Design features data and analytics, including trend analysis related to the value of energy optimization using zone controls, showing savings on a periodic basis. The continuous improvement on the house configuration of sensors and placement will be data collected as machine learning pattern algorithm and the cloud via the local compute module will include this as a design feature that provides quantifiable design improvements to the machine learned patterns that will be a feature chosen by the deep learning as an input to the building optimal design and the actual impact of Energy Efficiency Upgrades and other builder provided options.

Notification to all warranty providers and/or warranty actuaries. The immediate issues for maintenance in addition to ongoing issues that are already described for the builder and homeowner can also be made available to warranty manufacturers, equipment suppliers and microgrid operators on a contractually agreed upon need to know basis.

Electric Vehicle (EV) and the development of a robust EV charging infrastructure requires the homeowner to coordinate their vehicle as a grid support storage device. Standards that are in place by the Society of Automotive Engineers prescribes that the EV be made available to schedule grid support functions identical to any parallel connected energy generation device such as a solar inverter. This results in a requirement by standards definition to use vehicle-to-grid communications. The EV charge and discharge between the grid must be coordinated with the homeowner and the use of a machine learning algorithm that will perform pattern recognition of usage and availability and this will be used to manage a schedule for the required bi-directional operation.

Electric Vehicle (EV) and the development of a robust EV charging infrastructure requires the homeowner to manage multiple vehicles on a single charge and discharge device. This innovation includes a smart switch to charge a primary and secondary EV at separate times but from the same Receptacle. This requires the machine learning pattern to determine when each vehicle is available to take the position of charge or discharge. In addition to this schedule function the smart charging switch will also be required to sense an override because the EV in place already has a charge that meets the required level. The time of day will also be part of the pattern recognition because the vehicle inserted before the end of a solar energy production day will be available for grid stabilization, this stabilization is with flattening the demand curve from daytime solar production to early evening discharge of energy to the grid. This two-vehicle smart switch can be extended to a maximum of 3 EVs on the same home circuit. The significant savings here is the that without this smart switching, the main panel installation would have to be increased by 100+ AMPS to accommodate multiple EV chargers based on 60% diversity use on the main electrical panel, this addition of going from an average 200 amp panel to a 400 amp or 500 amp panel would make the difference between maintaining a price point that significantly increases a penalization to homeowner for participation in the upcoming EV addition to the climate decarbonization efforts in place and underway. Switched load management for each individual electric receptacle is controllable and is maintained as a database function during commissioning. Each individual outlet that is commissioned can be individually recommissioned at any time the API is run by the user.

### Example Embodiments

An example embodiment provides a user-defined demand response system comprising: (a) a means for accepting from a user a power-shedding goal, expressed as a percentage reduction in overall power consumption, a kilowatt-hour reduction, a dollar reduction, or a combination thereof; said means comprising, as an example, a computer or similar data processing system that includes a user interface that accepts from the user a selection from a plurality of predefined power shedding goals or an indication of a custom power shedding goal; (b) a means for tracking power consumption by the user and comparing to the power shedding goal, said means comprising, as an example, a smart power meter configured to measure the user's power consumption in real time; (c) an energy control system comprising, as examples, thermostats, electric vehicle charging stations, lighting, battery management systems, and other power-consumption systems, all configured to accept communications controlling the power consumption characteristics of the associated power consumption systems, and further comprising a computer or similar data processing system configured to communicate with the various power consumption systems to configure their operations to achieve the power-shedding goal, e.g., by adjusting thermostat temperatures for HVAC systems, adjusting charge rates for EV charging stations, adjusting lighting within the facility (e.g., the home or portion of the home), adjusting supply and charging of batteries.

A power shedding goal can be accepted from a user in various ways. As an example, a computer system can monitor the energy consumption of the facility and communicate with a user (e.g., the homeowner) when a predetermined condition is reached, e.g., when total power consumption exceeds a threshold, or when changes in power consumption (e.g., a rapid increase in power consumption) exceed a threshold, or when an external condition (e.g., cloud cover or nightfall indicating reduced solar production at the facility, or an indication that grid-supplied power will be more expensive or less available), or combinations thereof. The communication can comprise, as examples, a text message, an email, or a notification to a mobile device; and can include a request for the user to establish a power shedding goal, a suggestion for one or more power shedding goals that can be responsive to the condition determined by the monitoring system (e.g., power shedding goals can be related to the magnitude of reduced power supply or increased power cost). The power shedding goal can be expressed relative to the overall power consumption of the facility, or relative to specific power-consuming systems. (e.g., power shedding goals can be configured to minimize user discomfort, as examples thermostat changes can be minimized when the user is at home and awake, and maximized if the user is away or likely to be asleep; EV charging rates can be reduced but still configured so that the EV reaches full charge by a time when the user will typically be using the EV and appliances can be delayed to run at times when the total load profile will support their operation).

Power consumption can be tracked in any of various ways, including the following examples. Total power consumption can be tracked at a meter at the service entrance for the power of interest, e.g., an electrical service meter, or a gas service meter. Power consumption for lighting can be measured using sensors associated with specific lighting systems, e.g., sensors embedded in or associated with specific light switches or specific lighting devices. Power consumption for other electrical loads can be measured with sensors embedded in or associated with specific electrical outlets, or incorporated into devices that consume electrical energy. Devices that draw high amounts of electrical power often have power sensors already embedded, (e.g., EV charging stations which can work with the system to notify the user of their current usage as it relates to their power consumption goals).

Controlling the electrical system can be responsive to various principles, implemented in a computerized control system, including the following as examples. Loads can be shed in a predetermined order or priority established by the builder or a user. Loads in such a system can be shed partially or fully, (e.g., a system can be disabled as part of the shedding priority, while another system is reduced by 10% as an early load shed and by an addition 50% after other lower priority loads are shed). A user can override predetermined order or priority, (e.g., through the same or a similar user interface that accommodates the power shedding goal). HVAC loads can be shed by adjusting thermostat setpoints, e.g., to reduce overall requirements and to optimize duty cycles to reduce overall power consumption. HVAC loads can be shed for the entire facility or by zone, if the HVAC system accommodates zone-specific settings. HVAC loads can be shed based on user specification (e.g., “keep the living room comfortable”), user history (e.g., user is usually in the kitchen and dining room this time of day), and current and predicted weather conditions. Lighting loads can be shed by dimming or disabling specific lights or areas, and can be responsive to current occupancy (sensors in the facility, or direct user input such as turning on or off a device or light) or historical occupancy or planned (user device indicates just arrived at or just left home) occupancy (e.g., leave lights bright in rooms that are currently occupied or that are usually occupied in the current conditions such as time of day and day of week). EV charging loads can be shed by limiting EV charge current or disabling EV charging, and can be responsive to user-defined preferences, previous history (e.g., day of week and time of day the vehicle is typically driven and hours remaining until that time) or planned usage (e.g., user calendar indicating time of expected EV travel).

An example embodiment provides a system for optimizing electric vehicle battery health, comprising a home energy management system configured to: (a) collect data from a user's electrical vehicle when connected to a wall charger, including batter state-of-charge, and charging history; (b) monitor and analyze the collected data to determine the health and performance of the electrical vehicle battery; (c) implement conditioning and cycling protocols for the electric vehicle battery, tailored to optimize its health and performance, based on the analysis of the collected data; (d) generate recommendations for charging and usage patterns to further enhance the health and lifespan of the electric vehicle battery; (e) communicate the recommendations to the user through a user interface; where the user interface is configured to: (e1) display real-time information concerning the health and performance of the electric vehicle battery; (e2) provide feedback on the effectiveness of the implemented conditioning and cycling protocols; (e3) facilitate user interaction with the system by allowing the user to adjust charging settings and receive personalized recommendations.

Data can be collected from the electrical vehicle when connected to a wall charger by various means. Current wall chargers typically use the Open Charge Point Protocol (OCPP) to supply information about the charger and possibly the vehicle, e.g., current charger connection status, current charge current, power delivered in current charging session, maximum current allowed by the charger, system faults, vehicle identification number (VIN), and current vehicle state of charge.

The data can be monitored and analyzed to allow optimization by the control system of the vehicle charging. An OCPP connection provides various information about the current car charging status, as described above. This allows the system to track how often a car is charged, how much electricity is required, and when the car is likely to be disconnected. This can be used to optimize charging for load shedding or to take advantage of Time-of-Use (TOU) rates.

Conditioning and cycling protocols can be implemented, as an example, according to the requirements and capabilities of the vehicle.

Recommendations can be generated, as examples, based on charge history, and user travel plans (from calendar events, etc.) the system can make recommendations for how much charging might be required or remind users if the vehicle has not been plugged in or will not be charged sufficiently for a trip. The system can also configure charge scheduling to reduce cost by taking advantage of time-of-use rates, or excess solar/renewable power, while ensuring the vehicle always has sufficient charge to accomplish scheduled travel. These recommendations can be sent to the user, e.g., via weekly summary, by text message, or displayed in a kiosk or dashboard in a user interface such as those described herein.

Access to EV charging, and all system features can be available via a touchscreen kiosk inside the home, as well as a web dashboard, in communication with a computer system that provides the capabilities described herein such as consumption monitoring and load shedding. Many features and notifications can also be available via text message to the builder or homeowner as appropriate. Mobile application interaction can also be available.

An example embodiment provides a method for monitoring the health and status of a smart home using extended reality (XR) technology, comprising the steps of: (a) launching an XR application on a mobile device or smart device equipped with a camera; (b) identifying embedded sensors by utilizing the camera to scan the interior and exterior of the home to locate sensors embedded within the walls or other structures; (c) overlaying sensor data by generating an XR overlay that superimposes sensor data onto the real-world view captured by the camera; (d) displaying sensor readings by presenting real-time sensor readings and alerts for each identified sensor, including one or more of foundation sensor readings, air quality readings, moisture and leak detection readings, air filter and HVAC pressure readings, power monitoring data, and status information from other connected smart home devices; (e) visualizing sensor locations by highlighting the location of each sensor within the XR overlay, allowing users to easily identify and locate specific sensors; (f) monitoring overall home health by providing a comprehensive view of the overall health and status of the smart home by aggregating and analyzing data from multiple sensors; (g) identifying potential issues by utilizing sensor data and historical trends to identify potential issues or anomalies within the smart home, such as foundation settling, air quality concerns, moisture or leak detection, HVAC malfunctions, or power irregularities; (h) providing actionable insights by delivering actionable insights and recommendations to a homeowner based on the analysis of sensor data, enabling proactively addressing of potential problems and maintenance of the health of the smart home.

Launching an XR application on a mobile device or smart device equipped with a camera can comprise, as examples, an XR application that works on iOS or Android or other mobile operating system, and provides the user with a 3D overlay of their home, showing all of the systems and their statuses, and allows interaction with devices and the system.

Identifying embedded sensors by utilizing the camera to scan the interior and exterior of the home to locate sensors embedded within the walls or other structures can comprise, as an example, an XR application can align walls within the home and use the home touchscreen kiosk as a point of reference. It then loads the plans for the property, including expected positions of walls and sensors to allow for their placement throughout the home. The position accuracy of the walls and sensors is improved through the mobile device's cameras. The walls and sensors are redrawn with the perspective of the mobile device's camera, allowing the user to walk through the home and interact with sensors within their field of view.

Overlaying sensor data by generating an XR overlay that superimposes sensor data onto the real-world view captured by the camera can comprise, as examples, showing air temperature, relative humidity, particulate matter (e.g., PM2.5), CO2, and VOC, soil moisture below the facility, energy usage of the entire facility and of specific systems (e.g., specific lights or lighting circuits), open/closed status of doors and windows, status of thermostats, occupancy sensors, and water detection/flood sensors.

Displaying sensor readings by presenting real-time sensor readings and alerts can include, as examples, displaying sensor values, sensor values relative to previous, typical, or predicted values, graphical indications of sensor values, optionally with highlighting of sensor values that might merit attention (e.g., attention-grabbing words such as “URGENT” or “WARNING,” larger font, changed color for the sensor value or the system/region affected).

Visualizing sensor locations by highlighting the location of each sensor within the XR overlay, allowing users to easily identify and locate specific sensors can be done by, as examples, integrating the sensor value presentation as described above with an XR display of the facility.

Monitoring overall home health by providing a comprehensive view of the overall health and status of the smart home by aggregating and analyzing data from multiple sensors can include several functions, including the following examples. Data from all sensors within the home can be aggregated in a time-series database to allow for statistical analysis, and prediction of imminent events. The system can monitor predicted outside air temperature, and status of the main plumbing valve to warn users when pipe freezing is possible. The system can monitor changes in soil moisture underneath the foundation to predict uneven foundation settling. The system can use measured pressure across the air filter, HVAC operating time, as well as readings from air quality sensors within the home to indicate to the user that HVAC air filters should be replaced. The system can monitor water flow at the water meter, as well as sensors placed throughout the house to detect dripping faucets or leaking pipes.

Identifying potential issues by utilizing sensor data and historical trends to identify potential issues or anomalies within the smart home, such as foundation settling, air quality concerns, moisture or leak detection, HVAC malfunctions, or power irregularities. As an example, foundation settling can be determined as described above and then communicated by XR displays, text communications, warning tones or sounds, or via an in-home kiosk (e.g., tablet or display). HVAC and other malfunctions can be accommodated similarly.

Providing actionable insights by delivering actionable insights and recommendations to a homeowner based on the analysis of sensor data can enable proactively addressing of potential problems and maintenance of the health of the smart home, including the following examples. The system can provide information to the homeowner via text message, app, and web page notifications which can be used to modify behavior to improve home efficiency, and potentially save the homeowner money, e.g.: more optimal schedules for EV charging, to take advantage of Time-of-Use (TOU) rates, without impacting vehicle availability; more optimal thermostat setpoints and schedules to improve occupant comfort, take advantage of TOU rates, and help improve grid stability; notify homeowner of unnecessary energy usage, such as lights left on in empty homes, conditioning unoccupied spaces, doors/windows left open; and allow user to measure actual HVAC filter lifespan against manufacturers specifications, which also allows for cross brand evaluation.

An example embodiment provides a method for unifying the management and monitoring of smart devices and appliances within a smart home, comprising the steps of: (a) establishing a centralized Service Gateway by deploying a Service Gateway that serves as a central hub for communication and data exchange between various smart devices and appliances within the smart home; (b) integrating with 3rd party smart devices by utilizing standardized communication protocols to establish connections with a wide range of 3rd party smart devices and appliances, regardless of manufacturer or platform; c) collecting error codes and diagnostics by periodically polling connected smart devices and appliances to retrieve error codes, diagnostic information, and other relevant data related to their operation and health; (d) consolidating device information by aggregating and consolidating the collected error codes, diagnostics, and device information into a unified data repository; (e) visualizing device status by presenting a centralized dashboard that visualizes the status of all connected smart devices and appliances, providing a comprehensive overview of their operation and potential issues; (f) identifying device malfunctions by analyzing the collected error codes and diagnostics to identify potential malfunctions or anomalies within the connected smart devices and appliances; (g) generating maintenance alerts by generating timely alerts to homeowners when potential malfunctions or anomalies are detected, enabling proactive maintenance and troubleshooting; (h) enhancing efficiency and preventative maintenance by streamlining the process of monitoring, detecting, and addressing potential issues with smart devices and appliances, thereby enhancing the overall efficiency and preventative maintenance practices within the smart home.

Establishing a centralized Service Gateway can be done by deploying an Service Gateway that serves as a central hub for communication and data exchange between various smart devices and appliances within the smart home. Examples include (hardware, software that work for such a hub; communications standards (including Ethernet, Wi-Fi, Z Wave, Zigbee and POE). This would allow the system to receive current signals, transmissions, error codes, etc. off existing devices (furnace, water heater, refrigerator, etc.) and compile those values in the cloud connected database for monitoring, fault tracking, and alerts.

Integrating with 3rd party smart devices can be done by utilizing standardized communication protocols to establish connections with a wide range of 3rd party smart devices and appliances, regardless of manufacturer or platform. As examples, the system can integrate with standards such as ZWave, Zigbee, POE, MQTT, Matter. The system can integrate with smart devices such as motion sensors, occupancy sensors, door sensors, window sensors, air quality sensors, door locks, electrical vehicle service and equipment systems, flood sensors, energy monitors, light switches, and electric outlets. The system can also provide an API that facilitates integration of vendors for diagnostic messages, logs, and user interaction.

Collecting error codes and diagnostics can be done by periodically polling connected smart devices and appliances to retrieve error codes, diagnostic information, and other relevant data related to their operation and health. As examples, software faults, hardware faults, and diagnostic information from devices that support (e.g., using ZWave, Zigbee, POE, Matter, or WiFi) can be collected.

Consolidating device information by aggregating and consolidating the collected error codes, diagnostics, and device information into a unified data repository; can be done by consolidating into a database maintained by the system, e.g., in storage local to the home (e.g., connected to an in-home kiosk), or in remote storage (e.g., connected via the internet to storage provided by the user or by a third party provider).

Visualizing device status can be facilitated by presenting a centralized dashboard that visualizes the status of all connected smart devices and appliances, providing a comprehensive overview of their operation and potential issues.

Identifying device malfunctions can be done by analyzing the collected error codes and diagnostics to identify potential malfunctions or anomalies within the connected smart devices and appliances. As examples, the system can provide automated statistical analysis of facility power consumption and device errors, e.g., allowing detection of correlations between device function or error and other systems, such as determining that a device has lower performance at certain times of day or when certain other systems are on/off (e.g., a light system might consume more power when the room temperature is below/above a threshold, and that correlation can be used in optimizing load shedding as well as communicating potential device faults to the user).

Generating maintenance alerts by generating timely alerts to homeowners when potential malfunctions or anomalies are detected, enabling proactive maintenance and troubleshooting. As examples, air filter changes can be scheduled more optimally using sensors to detect filter usage, and indoor air quality; lighting replacements can be scheduled based on power consumption and light output sensors that allow prediction of future lifespan of a lighting device; water consumption monitoring can be used to identify leaking fixtures; electricity consumption monitoring can be used to identify devices running atypically, such as a failing HVAC blower, or refrigerator compressor. This system can also monitor the functionality and performance of an ERV (Energy Recovery Ventilator), HRV (Heat Recovery Ventilator), or fresh air intake fan. Additionally, it can communicate any malfunctions or operational issues to the property owner, warranty provider, or trade partner.

The system can enhance efficiency and preventative maintenance by streamlining the process of monitoring, detecting, and addressing potential issues with smart devices and appliances, thereby enhancing the overall efficiency and preventative maintenance practices within the smart home.

An example embodiment provides a method for recommending preconfigured automations, also known as “scenes,” for a smart home based on various factors, comprising the steps of: (a) gathering contextual data by collecting and analyzing contextual data relevant to the smart home environment, including location, weather conditions, time of day, time of year, and data from similar-sized homes in the area or neighboring communities; (b) leveraging aggregated data by utilizing aggregated data from a vast network of RIoT-enabled homes to identify patterns and correlations between contextual factors and effective smart home automations; (c) generating scene recommendations by, based on the analysis of contextual data and aggregated home data, generating personalized scene recommendations for each smart home, tailoring automations to optimize comfort, energy efficiency, and overall home functionality; (d) identifying user preferences by determining user preferences and routines through explicit user input, historical behavior analysis, or machine learning techniques; (e) generating scene recommendations by utilizing the gathered contextual data and identified user preferences to generate a set of preconfigured smart automation recommendations, referred to as “scenes;” (f) assessing scene relevance by evaluating the relevance and effectiveness of each recommended scene based on the current contextual factors and user preferences; (g) presenting scene recommendations by presenting the generated scene recommendations to the user through an intuitive interface, prioritizing the most relevant and impactful scenes; (h) enabling scene activation by providing the user with the option to easily activate or discard the recommended scenes, allowing them to seamlessly adopt the suggested automations; (i) continuously optimizing recommendations by continuously refining and improving scene recommendations based on user feedback, aggregated data from the entire database of RIoT-enabled homes, and advancements in machine learning algorithms.

Gathering contextual data can be done by collecting and analyzing contextual data relevant to the smart home environment, including location, weather conditions, time of day, time of year, and data from similar-sized homes in the area or neighboring communities. As an example, data to be analyzed for a specific facility can be collected from all connected homes in a neighborhood, or within a defined region or distance, or having some systems in common; and from third party systems such as weather conditions and predictions and utility grid status and costs.

Leveraging aggregated data can be done by utilizing aggregated data from a vast network of similarly-enabled homes to identify patterns and correlations between contextual factors and effective smart home automations. For example, data from all enabled homes can allow cross-comparison of similar data points where they appear. For example, timestream data over a given month which showcase significant temperature fluctuations between two neighborhoods within a small geographical area, can be analyzed (either manually by an interested builder, or through custom-built and automated pattern-matching to watch for such an event) to detect the effect of different material choices, building practices, or unexpected weather situations which can be considered in maintenance and upgrade of existing facilities and design and construction of new facilities.

Generating scene recommendations, based on the analysis of contextual data and aggregated home data, can be done by generating personalized scene recommendations for each smart home, tailoring automations to optimize comfort, energy efficiency, and overall home functionality.

Identifying user preferences by determining user preferences and routines through explicit user input, historical behavior analysis, or machine learning techniques. As an example, if a user turns a thermostat down every day at a specific time, the thermostat can be automatically configured to make the same adjustment. This can further consider the occupancy of the building, or even specific rooms (e.g., “the user turns down the thermostat when he leaves the kitchen after 6 PM”). Similar analysis and control can be applied to lighting systems. Schedules from one or more users can also be used to identify user preferences, e.g., from one or more user electronic calendars, e.g., to configure EV charging, lighting, alarm clocks (e.g., “the user is leaving early for a meeting tomorrow, so configure the EV to be fully charged earlier than usual,” or “the user is returning later than usual tomorrow, so delay turning up thermostat or on lights relative to normal”).

Generating scene recommendations by utilizing the gathered contextual data and identified user preferences to generate a set of preconfigured smart automation recommendations, referred to as “scenes.” Some scenes can be implemented to meet basic home requirements (e.g., closing water supply valves to prevent pipe freezing, or adjusting thermostat setpoints to prevent similar damage). User preferences can be used to build scenes as described above.

Assessing scene relevance by evaluating the relevance and effectiveness of each recommended scene based on the current contextual factors and user preferences can facilitate integration of scenes with user preferences.

Presenting scene recommendations by presenting the generated scene recommendations to the user through an intuitive interface, prioritizing the most relevant and impactful scenes. E.g., scenes, both generated and manually configured, can be presented to the user in the dashboard and kiosk UI, where they can be enabled, disabled, or modified by the user.

Enabling scene activation by providing the user with the option to easily activate or discard the recommended scenes, allowing them to seamlessly adopt the suggested automations. Scenes can be controlled through the dashboard, or kiosk UI. When a scene is adopted, it becomes part of the automation system for this home. This allows a response to its triggered events within the home.

Continuously optimizing recommendations by continuously refining and improving scene recommendations based on user feedback, aggregated data from the entire database of RIoT-enabled homes, and advancements in machine learning algorithms. As scenes are activated, user responses to the physical changes happening in the home can be interrupted or further modified by the user. As an example, if a scene results in an autonomous lighting change, but the user immediately changes the lighting afterwards, this feedback can be used to adjust future scene activations. Additionally, other users, taking advantage of the same scene in other homes, can have their interaction with their homes used to improve the functionality of generated scenes for their own home, and for optimization in other homes.

Embodiments of the present invention are related to the field of smart home building control, specifically: provision of occupant comfort, efficient energy performance, maintenance issue identification, evaluation of quality of dwelling design for continuous construction and operational improvements, and cost reduction in building and operating residential dwellings.

As used herein, “smart home” refers to technology that facilitates one or more collection of data concerning conditions in a dwelling, control of one or more systems in a dwelling, and communication of status, faults, or prospective problems. A “dwelling” or “home” refers to any structure intended for human occupancy, and in particular includes single family detached homes, town homes, duplexes, and multifamily structures such as apartment or condominium buildings, including individual units, such buildings as well as collections of units and such buildings as a whole.

The present invention can be especially useful in connection with high volume production of smart homes. Integrating smart home technology raises many issues for production builders who construct the large majority of residential dwellings. These builders focus on optimizing building design to meet homeowner lifestyles at the lowest cost and with the fastest construction techniques. Recently, production builders have been under pressure from homeowners and governments to include building automation and energy management features into their homes. This requires a skill set that is unfamiliar to production builders and introduces a level of complexity in specifying sensors, actuators, controllers, and IT systems that is beyond the focus of production builders.

Retrofit smart home systems. There are a number of sensor systems available to residential dwelling owners that are designed for retrofit installation. These systems most frequently relate to security and home automation functions such as control of locks, garage doors, and lighting. They are often battery powered and therefore subject to ongoing maintenance by the building occupant. Further, such retrofit systems use various wireless or wired communications protocols to transmit data and to affect control functions. The homeowner must have multiple apps on a smartphone to coordinate operation of such systems, and such apps require regular updating. If the homeowner chooses to use a system that is capable of combining multiple sensors and actuators using a particular communications protocol and display technology, then the skill level required to perform and maintain such integration is beyond the capacity or patience of many people, including those who specialize in integrating home automation systems. Consequently, it is a frustratingly complex task to integrate and configure such systems and to maintain their consistent operation.

Beyond smart homes. There are useful functions beyond home automation and energy management that can be obtained once a residential dwelling is configured with multiple sensors and actuators and is connected to a data collection and analytics facility. For example, production home builders have been shown to value information about the performance of the dwellings so that they can avoid warranty issues, validate the performance of their buildings over time, assist the homeowner by managing maintenance issues before they become larger problems, and assure cybersecurity of multiple internet-connected sensor and actuator devices.

Dwelling management. In conventional construction of residential dwellings, systems in the building are built and installed without sensor data collection, without data analytics and without machine learning and pattern recognition. Any data on the status or performance of the building systems is collected in conventional construction with manual ad hoc methods. Since collection is ad hoc, a baseline for the building or the systems does not exist. There is no continuous data collection, or time-stamped information. Detection of error conditions and management of systems to avoid errors or to improve performance is not possible. Additionally, where there are some sensors installed at homes, the power to sensors, in conventional construction, uses batteries for sensors and controlled valves and switches. Consequently, the systems can be vulnerable to power loss and interruptions.

Current approaches in residential construction limit management of short term performance issues and long term design evaluation of the residential buildings. The short-term maintenance issues are not captured with current methods because there is no centralized data repository in existence that captures the data from a variety of sensors that exist in a ‘multi-variable’ platform to capture performance data from residential homes. Subsequently, homeowners are unaware of building performance issues, maintenance issues and resource inefficiencies. Additionally, machine-learned and pattern recognition of normal patterns are nonexistent and thus cannot be made available for comparison to error conditions that are indicated by local sensors then evaluated using cloud data and analytics with a return notification for resolution to a local control module. The long term building design improvement and performance evaluation are not captured at present since there is no continuous data collection to the cloud from local sensors for this purpose. The aggregated data use for analytics by the builder, insurance provider, homeowner and other constituents are not available to these users with current approaches.

Security management. Having many internet-connected devices in a home connected to a Wi-Fi network introduces potential cybersecurity weaknesses, including DDoS (distributed denial of service) attacks using such devices, incapacitating dwelling functions, and identity theft. Production builders and homeowners recognize these threats and have expressed interest in preventing issues.

Production builders construct over 1 million dwellings per year in the US and that these dwellings are to standardized designs that are repeated over and over. The builders want to include smart home features in these dwellings but are faced with a complicated choice of which sensors and actuators to include, how to install them, how they are to be managed by the average homeowner, and how they might derive value from such a system. Embodiments of the present invention can simplify and standardize the design and installation of secure smart home systems by providing production builders with a pre-configured installation-ready sensor and actuator system with associated analytics.

Example embodiments of the present invention provide one or more of the following characteristics: Pre-configured system; Not for retrofit; rather standardized for repetitive construction of same building plan; including details of integration with plan (e.g., wiring, placement); Without battery power for operation, only for keep alive memory; Providing remote IoT security; Ability to physically disconnect from home locally by manual switch of via remote command (possibly requiring a manual reset); Comprising a number of sensors, controls, and actuators including as examples minimum HVAC, security, lighting, energy, water; Connected to a local gateway device by which the IoT devices can be remotely managed and can send information to an offsite management location; A management location that collects data and dispatches maintenance; EV charger not internet connected to avoid security risk (e.g., only connected to local controller with firewall between).

An example embodiment of the present invention comprises a home automation system kit comprising a plurality of subkits, each subkit comprising one or more of: (a) one or more sensors, each configured to be powered by house mains and to produce a signal representative of the status or performance of a dwelling condition; (b) one or more actuators, each configured be powered by house mains and to accept a control signal and to change the state of a house system responsive to the control signal; (d) a programmed data processor configured prior to physical installation in the dwelling to accept signals from sensors in any of the subkits and produce control signals for actuators in any of the subkits; wherein the sensors and actuators in each subkit are matched to the same Construction Trade and the same phase of dwelling construction; and wherein the programmed data processor is configured to provide smart home functions using the sensors and actuators without requiring onsite configuration or programming.

Sensors configured to be powered by house mains and to produce a signal representative of the status or performance of a dwelling condition include, as examples, sensors indicative of Motion and Presence, Air and Water Temperature, Humidity Levels, Light Levels, Air Quality, CO2 Level, VOC level, Smoke and Fire detectors, Heat/Fire, Sound, Pressure Differentials, Energy Usage, Water Leaks, Water Pressure and Flow, Noise Level, Window and Door Status, Appliance Status, Structural Integrity, Weather Conditions, Occupancy Presence and Patterns, Health Monitoring, UV light, Pressure sensors (e.g., in floors), Vibration sensors (e.g., in floors), Proximity sensors (e.g., to detect variations in occupancy), Camera sensors (e.g., to feed image recognition software to detect occupancy or configuration of dwelling elements such as changes in in location or orientation of appliances), and Soil Moisture.

Actuators configured be powered by house mains and to accept a control signal and to change the state of a house system, include actuators that control house systems such as Lighting Control, Climate Control, Security and Surveillance, Energy Consumption (e.g., gas and electric), Appliance Control, Water Usage, Window and Blinds Control, Air Quality Monitoring, Access Control.

Construction of dwellings is done by distinct Construction Trades, where a Construction Trade refers to the hands-on professions that are directly involved in the physical construction of buildings. Examples include carpenters, masons, electricians, plumbers, painters, roofers, and HVAC technicians. Each trade specializes in a specific aspect of construction and typically requires specific training and certification. Organizing the kit according to Construction Trade enables each Trade to have all, and only, the components that are needed for their work. This reduces the chance of confusion, theft, or faulty construction (e.g., where a component is installed or misidentified by the wrong Trade. Previously, smart home components would be installed by a specialist in that technology, requiring schedule and access coordination among those specialists and all the various Trades that work on the dwelling.

Construction of a dwelling is also generally accomplished over a plurality of Construction Phases. These phases are typically Pre-Construction and Planning Phase; Foundation Work; Framing Phase; Mechanical, Electrical, and Plumbing (MEP); Enclosure; Interior Finishing; Final Touches; Final Inspection and Close-out; Handover; and Warranty Coverage. Organizing the kit by Construction Phase allows only those components that are to be installed in the current phase to be delivered to the site, further limiting the chance of theft and confusion.

Embodiments of the invention provide any of various smart home functions, including as examples Property Maintenance, Tenant Management, Financial Management, Security Management, Energy Management, Communication Tools, Inventory Control, Emergency Protocols, Compliance Monitoring, and Smart Home Features Integration.

Sensors can comprises, as examples, sensors comprise one or more of Motion sensors, Temperature sensors, Humidity sensors, Light sensors, Air quality sensors, Energy usage meters, Water leak sensors, Window and door contact sensors, Smoke and Fire sensors, Water Temperature Sensors, Water Pressure and Flow sensors, Noise detection (for example glass break) and noise level sensors, Occupancy sensors, UV light sensors, Pressure sensors, Vibration sensors, Proximity sensors, Soil moisture sensors, Camera sensors, and Pressure Sensors.

Actuators can comprise, as examples, Electric door locks, Motorized window openers, Motorized blind and curtain controls, HVAC dampers, Radiator valves, Thermostatic valves, Electric water valves, Solenoid valves, Garage door openers, Motorized pet doors, Motorized projector screens, Smart light switches and dimmers, Fan controls, Smart plugs and outlets.

In some embodiments, the programmed data processor is configured to use input from a plurality of sensors, indicative of a plurality of distinct home conditions to determine the presence of home conditions that indicate communication of potential faults to a user of the home automation system. As examples, Room occupancy (presence or absence of people), Temperature changes in various rooms or areas, Humidity levels indoors and outdoors, Ambient light levels (natural and artificial), Sound levels (noise pollution or security breaches), Air quality (presence of smoke, VOCs, carbon monoxide, etc.), Water leaks or flooding in specific areas, Door and window status (open or closed), Energy consumption of appliances and systems, Movement or vibrations (indicative of security breaches or structural issues), Weather conditions outside (temperature, rain, wind), Soil moisture levels, UV exposure (for managing sun shades or alerting to high UV index), Electrical system status (circuit loads, faults), Gas or carbon monoxide presence), can be integrated to more accurately infer and diagnose home conditions than is possible with a conventional single sensor.

As an example, the programmed data processor can be configured to communicate an indication of HVAC filter replacement responsive to sensors indicating two or more of: air pressure upstream of the HVAC filter, air pressure downstream of the HVAC filter, power consumption of a fan in the HVAC system, run time for the HVAC system to reach a determined temperature, and the opening of a filter access door. The opening of the filter access door indicates an attempt to change the filter or examine its condition. The condition of the air filter can be subsequently ascertained by comparing two or more of the above noted conditions before and after the filter door is opened. For example, the difference in air pressure between upstream and downstream of the filter, plus run time of the HVAC system to reach determined temperature, plus the noise level recorded at specific registers can provide confirmation that the air filter was changed or not changed.

As an example, the programmed data processor can be configured to communicate an indication of an intrusion responsive to sensors indicating two or more of: opening of an external entry point (such as a door, window, hatch, dog door or any other opening from outside to inside), change in air pressure in the house, motion detection, sound detection, light controls. e.g., motion sensed but no lights sensed might be just a pet traveling through the dwelling, while a pressure change plus motion plus lights turned on suggests intrusion even if the entry point sensors don't indicate that an entry point was opened. An intruder who somehow defeats or evades the door sensors can still be detected, from the change in air pressure in the dwelling when the intruder entered, plus the act of lighting the premises (by turning on lights or a flashlight), plus detection of motion in the dwelling. A pet moving through the dwelling can generate false intrusion alarms based solely on motion detection, but those false alarms can be detected when there is no additional illumination, and when there is no change in air pressure in the home.

As an example, the programmed data processor can be configured to determine a fault condition responsive to a sensor indicating a home condition outside of allowable parameters, where the allowable parameters are dependent on the operating status of one or more home appliances. E.g., if a cooktop burner is inadvertently left on there will be an increase in air particulates and detectable gasses within the dwelling. For an electric/induction cooktop, there will be a corresponding indication of electrical consumption. In addition, the passive infrared security sensor has not detected motion in the kitchen for a determined period of time. Fusing these sensor inputs, the system can infer that the cooktop has been left on inadvertently and alert the owner or external management service, or electrically disconnect the cooktop.

In some embodiments, the programmed data processor can be configured to communicate remediation steps to a user of the system, wherein the remediation steps are responsive to a particular fault detected, and by sensing of conditions that are affected by the execution of remediation steps. E.g., the system can instruct the user to “turn off washer,” and then sense electrical power and water flow at the washer. The next instruction from the system can then depend on whether those sensors indicate that the washer is no longer operating. E.g., if the electrical power is off, but water is still flowing, then the system can guide the user in finding a water leak. Or, if the water is not flowing, but the washer is still consuming electrical power, then the system can guide the user in diagnosing an electrical fault.

In some embodiments, the programmed data processor can be configured to determine a period when water flow into the home is at a minimum, and to indicate a leak of the minimum water flow is above a predetermined threshold. E.g., at certain hours of the day, if all sensors indicate that no water consuming devices are operating, then the water flow into the dwelling should be zero. Nonzero flow suggests a leak. Such a leak can be further localized using humidity sensors, as an example.

Some embodiments further comprise a mechanical switch that, when activated by a user, physically prevents the programmed data processor from communicating via the network. Allowing a “air gap” between the system and the outside world can be important to prevent or stop undesired external control or download. E.g., if an external “bad actor” has gained control of the smart home via the network, manually separating the system from the network with a switch can allow the user of the dwelling to regain control, since there will then be no physical connection to the network. Manually activated “air gap” switches are not subject to remote electronic hacking.

In some embodiments, the programmed data processor can be configured to operate the home according to a connected operating model where data is communicated to the network and commands are accepted from the network, or according to an island operating model where data is not communicated to the network and commands are not accepted from the network. This allows the dwelling to be operated with full functionality while a desired, secure connection to the network if available, while still allowing robust smart home operation in island mode when the external network is unavailable or has been compromised such as by a hacker.

In some embodiments, the programmed data processor further can operate according to a safe mode, where operating parameters are limited to ranges that are not configurable. This allows the dwelling to operate as a smart home, with reduced controllability, in the event of a hostile takeover. E.g., if a hacker takes over the system and sets the HVAC thermostat excessively high, or turns on excessive number of electrical loads, the system can be set into safe mode (e.g., manually, or by detecting the intrusion of the undesirable operation) and the system constrained to operate within the non configurable limits (e.g., HVAC between 65 and 80 degrees, or limited total electrical consumption).

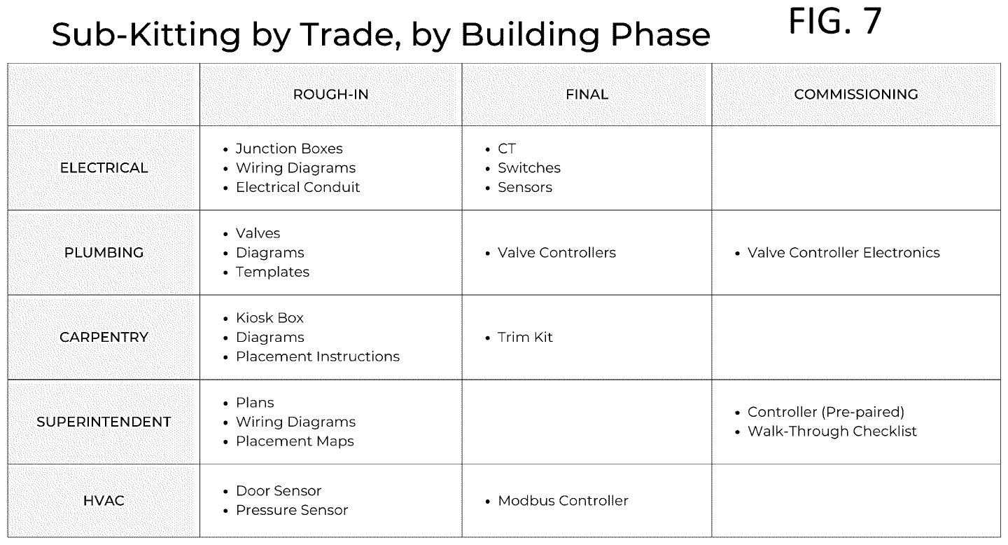

FIG. 7 is an illustration of sub-kits according to an example embodiment of the invention. An entire smart home system is realized by the combination of the various sub-kits. A first sub-kit corresponds to the rough-in phase of construction, as shown in the column headed “ROUGH-IN.” The ROUGH-IN sub-kit is further divided into 5 separate sub-kits, corresponding respectively to electrical, plumbing, carpentry, superintendent, and HVAC building trades. The rough-in sub-kit can be delivered at the rough-in phase of construction, and then each further sub-kit can be accessed by the appropriate trade. The risk of lost or misplaced components is greatly reduced, since only the components needed by a particular trade at this phase of construction are available. The risk that a component will not be installed at the proper time is also reduced, since all the components in a particular sub-kit should be installed by the corresponding trade.

A second sub-kit corresponds to the FINAL column, the final phase of building construction. This sub-kit is similarly subdivided according to applicable building trade. A final sub-kit corresponds to the COMMISSIONING column and is divided into two further sub-kits.

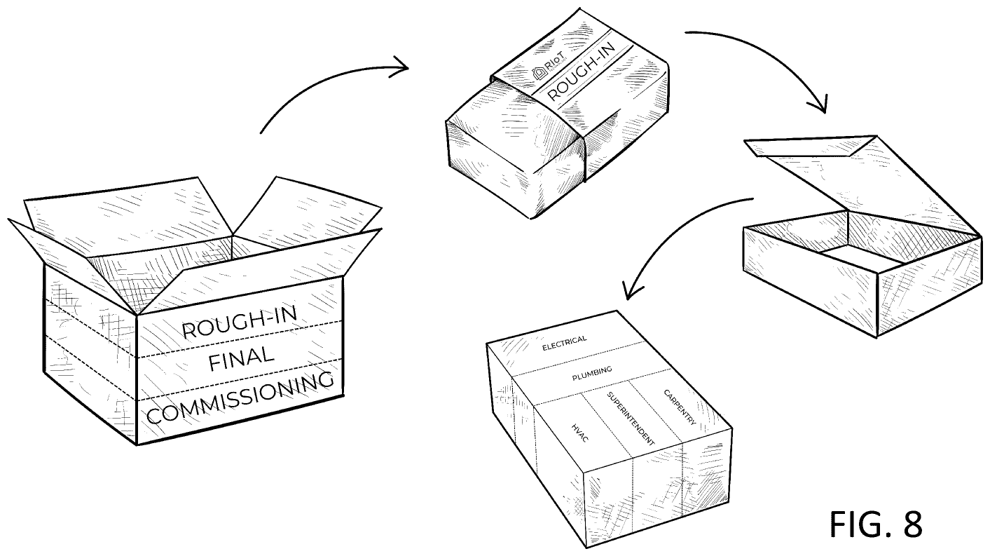

FIG. 8 is an illustration of sub-kits according to an example embodiment of the invention. The boxes are labeled with a name “RIOT” and a loge, which are trademarks of their owners. The box on the left in the figure depicts packaging o the entire smart home system. The entire system is subdivided into three sub-kits, illustrated by the dashed lines on the box and labeled ROUGH-IN, FINAL, and COMMISSIONING. Opening the box provides access to the first sub-kits needed, those for the rough-in phase of construction. The ROUGH-IN box is shown removed at the top and opened at the right of the figure. Within the ROUGH-IN box are 5 smaller boxes, each containing a sub-kit applicable to the ROUGH-IN phase of construction to be used by the corresponding particular building trade.

The present invention has been described in connection with various example embodiments. It will be understood that the above descriptions are merely illustrative of the applications of the principles of the present invention, the scope of which is to be determined by the claims viewed in light of the specification. Other variants and modifications of the invention will be apparent to those skilled in the art.

What is claimed is:

1. A home automation system kit comprising a plurality of subkits, each subkit comprising one or more of: (a) one or more sensors, each configured to be powered by house mains and to produce a signal representative of the status or performance of a house condition; (b) one or more actuators, each configured be powered by house mains and to accept a control signal and to change the state of a house system responsive to the control signal; (c) a programmed data processor configured prior to physical installation in the dwelling to accept signals from sensors in any of the sub kits and produce control signals for actuators in any of the sub kits; wherein each sub-kit, the sensors and actuators are specifically matched to correspond with the same construction trade and the same phase of construction; and wherein the programmed data processor is configured to provide one or more smart home functions using the sensors and actuators without onsite configuration or programming.

2. The kit of claim 1, wherein the one or more sensors comprise one or more of Motion sensors, Temperature sensors, Humidity sensors, Light sensors, Air quality sensors, Formaldehyde (HCHO) and Total Volatile Organic Compounds (TVOC) Sensors, the CO2 Detectors, the PM 10 and PM 2.5 Particle Sensors, the hydrogen peroxide meters, Energy usage meters, Water leak sensors, Window and door contact sensors, Smoke and Fire sensors, Water Temperature Sensors, Water Pressure and Flow sensors, Noise detection sensors, glass break sensors, noise level sensors, Occupancy sensors, UV light sensors, Pressure sensors, Vibration sensors, Proximity sensors, Soil moisture sensors, Camera sensors, and Pressure Sensors.

3. The kit of claim 1, wherein the one or more actuators comprise one or more of Electric door locks, Motorized window openers, Motorized blind and curtain controls, HVAC dampers, Radiator valves, Thermostatic valves, Electric water valves, Solenoid valves, Garage door openers, Motorized pet doors, Motorized projector screens, Smart light switches and dimmers, Fan controls, Smart plugs and outlets.

4. The kit of claim 1, further comprising a network connection interface configured to place the programmed data processor in communication with a network external to a home where the programmed data processor is installed, and wherein the programmed data processor is configured to communicate sensor information and actuator status via the network, and to accept commands from the network.

5. The kit of claim 1, wherein the programmed data processor is configured to use input from a plurality of sensors, indicative of a plurality of distinct home conditions to determine the presence of home conditions that indicate communication of potential faults to a user of the home automation system.

6. The kit of claim 5, wherein the programmed data processor is configured to communicate an indication of HVAC filter replacement responsive to sensors indicating two or more of: air pressure upstream of the HVAC filter, air pressure downstream of the HVAC filter, power consumption of a fan in the HVAC system, run time for the HVAC system to reach a determined temperature; opening of an access port to the filter.

7. The kit of claim 5, wherein the programmed data processor is configured to communicate an indication of an intrusion responsive to sensors indicating two or more of: opening of an external entry point, change in air pressure in the house, motion detection, sound detection, light controls.

8. The kit of claim 1, wherein the programmed data processor is configured to determine a fault condition responsive to a sensor indicating a home condition outside of allowable parameters, where the allowable parameters are dependent on the operating status of one or more home appliances.

9. The kit of claim 1, wherein the programmed data processor is configured to communicate remediation steps to a user of the system, wherein the remediation steps are responsive to a particular fault detected, and by sensing of conditions that are affected by the execution of remediation steps.

10. The kit of claim 1, wherein the programmed data processor is configured to determine a time period when water flow into the home is at a minimum or at zero, and to indicate a leak if the minimum water flow is above a predetermined threshold during the determined time period.

11. The kit of claim 4, further comprising a mechanical switch that, when activated by a user, physically prevents the programmed data processor from communicating via the network.

12. The kit of claim 4, wherein the programmed data processor is configured to operate the home according to a connected operating model where data is communicated to the network and commands are accepted from the network, or according to an island operating model where data is not communicated to the network and commands are not accepted from the network.

13. The kit of claim 12, wherein the programmed data processor is further configured to operate the home according to a safe operating model where systems of the home are controlled according to operating parameters that are not configurable by the programmed data processor.

14. The kit of claim 12, where selection among the operating models is responsive to input from a user physically present in the home.

15. The kit of claim 12, where selection among the operating models is responsive to input from a network analyzer that determines the presence of an unwanted corruption or misdirection of the system and selects the island operating model.

16. The kit of claim 1, comprising an EV charging system, and wherein the programmed data processor is configured to control operation of the EV charging system and other high power requirement systems of the home so that the net power consumption of the home accommodates time of day energy rates or other user preferences.

17. The kit of claim 1, further comprising:
(a) an augmented reality module configured to visually represent the physical locations of said sensors within the house in three dimensions on a user interface;
(b) wherein the user interface is enabled to display a real-time, augmented reality view of the house's interior, overlaying icons representing the sensors at their respective physical locations as determined by the sensor data processing module;
(c) wherein each icon is selectable via the user interface to display specific data related to the corresponding sensor, including but not limited to type, status, and last recorded data point.
